(19) United States
(12) Patent Application Publication
(10) Pub. No.: US 2006/0138079 A1
(43) Pub. Date: Jun. 29, 2006

(54) Fabrication process of microfluidic devices

(76) Inventors: Radislav Alexandrovich Potyrailo, Niskayuna, NY (US); Scott Martell Boyette, New Hope, PA (US); Canan Uslu Hardwicke, Niskayuna, NY (US); Andrew Michael Leach, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/021,399

(22) Filed: Dec. 27, 2004

(51) Int. Cl. B23P 15/00; B29C 33/40; B05D 1/36; B29C 35/08

(52) U.S. Cl. 216/39; 427/402; 264/496; 264/227

(57) ABSTRACT

A method for making a microfluidic device comprises providing a processing substrate, forming a negative stamp on the processing substrate using a direct write process, disposing a coating material on the processing substrate, curing the coating material to produce a cured coating material, and separating the processing substrate and the negative stamp from the cured coating material, wherein a plurality of channels are formed in the cured coating material corresponding to a location of the negative stamp.

### BACKGROUND

The present invention pertains generally to microfluidic devices and particularly to fabrication processes of microfluidic devices.

Microfluidic devices are used in a number of analytical, chemical and biochemical operations. Microfluidic devices employ a network of integrated microchannels in which fluids are transported, mixed, reacted and detected. Microfluidic devices increase the throughput of chemical analysis and decrease the required sample and reagent volumes. The small reaction volumes and handling of multiple samples at once make these systems very attractive for total chemical analysis, ultra high-throughput screening, and other applications.

Fabrication of microfluidic devices involves multiple processing steps. The reduction in the number of fabrication steps may reduce the variability of the fabricated product and improve its performance. A typical microfluidic chip consists of at least two parts where a first part is a substrate and a second part is a micro-fabricated structure that contains microfluidic channels.

Potential of the microfluidic devices depends on their fabrication methods and the ease of accomplishing the same. A variety of microfluidic chip fabrication techniques are known. To fabricate a chip, often a master is fabricated (typically in silicon) followed by replication of a microfluidic chip from the master. Existing master fabrication methods include wet silicon etching, dry silicon etching, optical lithography and electroforming, laser ablation and electroforming, and mechanical micro machining. Microfluidic devices may also be made using imprinting, hot embossing, injection molding, soft lithography, laser photo-ablation, X-ray lithography, low energy ion beam etching (IBE), plasma etching, and UV patterning of photoresists.

In another method for microfluidic channel fabrication, in contrast to the conventional practice of fabricating fluid channels as trenches or grooves in a substrate, the fluid channels are fabricated as thin walled raised structures on a substrate. A method for mass production of micro-optic elements using gray scale mask also is known. An advantage of using gray scale mask processing is that the single mask contains all the information necessary for generating multi phase levels, i.e., the three-dimensional contours required in a diffractive optical element and the like.

Some of the disadvantages of the prior techniques are the involvement of multiple processing steps, which in turn lower the efficiency of the process and also curb the competency of the system. Techniques like gray scale mask processing which avoid multiple processing steps by providing a single mask, are limited due to the high cost involved in mask generation process. Also, the multiple direct write steps involved in mask generation of the single mask of the gray scale mask processing sets limitations on resolution.

Hence a need for simplification of the fabrication process exists.

### SUMMARY

In one aspect of the invention, a method for making a microfluidic device is provided. The method includes providing a processing substrate, forming a negative stamp on the processing substrate using a direct write process, disposing a coating material on the processing substrate, curing the coating material to produce a cured coating material, and separating the processing substrate and the negative stamp from the cured coating material, wherein a plurality of channels are formed in the cured coating material corresponding to a location of the negative stamp.

In another aspect of the invention, a method for making a microfluidic device is provided. The method comprises attaching a device substrate to the cured coating material adjacent to the plurality of channels, and modifying the plurality of channels, wherein the modifying comprises disposing at least one reagent emitting material into at least one of the plurality of channels.

### BRIEF DESCRIPTION OF THE DRAWINGS

FIG. 1 is a cross-sectional view of an assembled microfluidic device constructed in accordance with an exemplary embodiment of the invention.

FIGS. 2A-2D illustrate various processing steps for fabricating the microfluidic device of FIG. 1.

FIGS. 3A-3E illustrate cross sectional views of a microfluidic device employing different patterns of reagent emitting materials according to various embodiments of the invention.

FIGS. 4A-4C illustrate various steps involved in the fabrication of the reagent emitting material in the microfluidic channel according to an embodiment of the invention.

FIGS. 5A-5C illustrate various steps involved in the fabrication of the reagent emitting material having a photoactive matrix in the microfluidic channel according to an embodiment of the invention.

FIG. 6 is a graph illustrating spectra of an immobilized chemical sensor in microfluidic channels upon the variation of pH.

### DETAILED DESCRIPTION OF PREFERRED EMBODIMENTS

A microfluidic device 10 comprises a device substrate 14 having a plurality of microfluidic channels 12 disposed in a polymeric coating 20. The device substrate 14 has at least one inlet fluidic port 16 and at least one outlet fluidic port 18. The microfluidic device 10 is fabricated using a direct write process as described in detail below. In one embodiment, the microfluidic device 10 has more than one inlet 16. In another embodiment, the microfluidic device 10 has more than one outlet 18. The combination of at least one microfluidic channel along with the device substrate 14 may also be referred to as a chip for the purpose of the application.

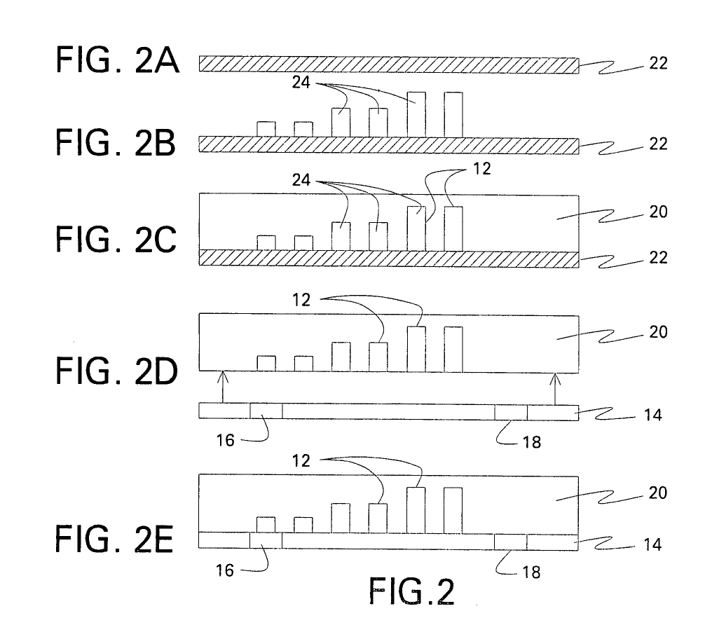

In one aspect of the invention, a method of fabricating a microfluidic device 10 is provided. The fabrication steps of a microfluidic device 10 made by direct write process are depicted in FIGS. 2A-2E. As shown in FIG. 2A, a processing substrate 22 is provided to deposit negative stamps 24. In one embodiment, the processing substrate 22 is made of materials such as, silicon, glass, quartz, gold, silver and the like. In the embodiment illustrated in FIG. 2A, the surface of the processing substrate 22 is flat.

In another embodiment, the surface of the processing substrate 22 is substantially non-flat and comprises flat and non-flat regions. In this embodiment, the direct write process may be applied on the flat regions, or non-flat regions, or both. In another embodiment, the processing substrate 22 has a non-flat surface such that the non-flat surface has at least one axis. In this embodiment, the direct write process forms a serpentine channel, such as a spiral, where the axis of the spiral is along the at least one axis of the non-flat surface. This choice of flat and non-flat surfaces provides the capability to match the shape of the final microfluidic structure with existing analytical and other systems and structures.

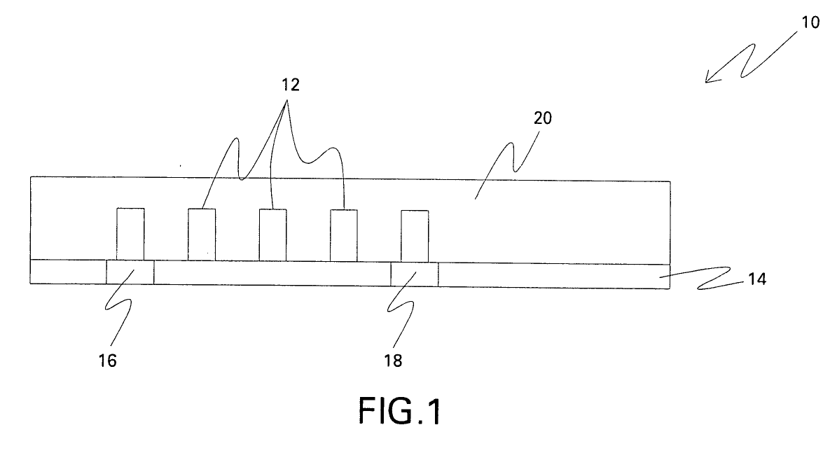

As shown in FIG. 2B, negative stamps 24 are produced on the processing substrate 22 by way of the direct write process. Typically, negative stamps 24 are protrusions, which are negative imprints of the microfluidic channels 12 (FIG. 1) of the microfluidic device 10 (FIG. 1). In one embodiment, negative stamps are made of ink containing metal, monomer, oligomer, polymer, ceramic powder particles, and other compounds. The ink material is selected to be compatible with the substrate used for strength and retaining of shape after drying and conditioning. Advantageously, the use of direct write process reduces the number of steps involved in the fabrication of the microfluidic device 10. As a result, enhanced efficiency of the fabrication process and added features in the microfluidic device 10 are achieved. By using a direct write process, negative stamps 24 having varying lengths may be fabricated. Varying the lengths of microfluidic channels 12 in a microfluidic device 10 provides the means for fluid manipulations, such as, for example, mixing and control of the fluidic volume for on-chip and off-chip detection.

The direct write process enables incorporation of any needed functionality into the ink for further modification of microfluidic channels 12. Modification of the functionality of the direct-write ink itself can be performed, for example, for further chemical modification of channels and other applications. In an embodiment, incorporation of chemical reagents onto or into the negative stamps 24 on the processing substrate 22 facilitates chemical modification of respective microfluidic channels 12. In general, the function of the reagent may be to affect the curing process of the coating at discrete locations, provide differences in physical and/or chemical properties of the discrete locations, ease of removal of coating materials after curing of the coating, and provide capability for chemical and biological response of discrete locations, where the discrete locations are regions forming the microfluidic channels 12.

Micro patterning of the negative stamps 24 may be done for generation of respective physical features in the microfluidic channels 12. These physical features can induce, or enhance a chemical modification of the fluidic channel, and this results in a chemically modified feature. One non-limiting example of physical features that enhance chemical modification is induced surface roughness. Induced surface roughness allows chemically modifying material to adhere more tightly to the microfluidic channel 12. Induced surface roughness may also facilitate mixing of liquids in microchannels. Another non-limiting example of induction is a polarized surfaces that increases the adhesion of deposited chemically modifying materials by increasing electrostatic interactions between the channel surface and the deposited material.

These features lead to the multiple-purpose use of microfluidic channels 12. The induced physical features for example, promote more efficient mixing and reduce the length of the channels required for adequate mixing. Additionally, the physical features also may increase mass and heat transfer in the microfluidic channels. The induced chemical features, for example, promote chemical modification of a channel. This chemical modification can be used for sensor applications and for improvement of the microfluidic channel 12 performances, such as decrease in diffusion of the fluidic components into the chip during the sample manipulation. Direct write process enables production of negative stamps 24 having relatively greater strength and rigidity, which allows higher production throughput of the microfluidic devices 10. Also, the direct write process facilitates production of microfluidic templates, using materials with much lower thermal expansion and compressibility that assure production of channels having similar or like dimensions while using different fabrication materials at different production temperatures and pressures.

As shown in FIG. 2C, a substrate 18 is provided. Ink is provided to produce negative stamps 24. A coating 20 is applied on the negative stamps 24. In one embodiment, the coating includes a monomer or oligomer, such as, for example, siloxane, hydroxyethyl methacrylate, multifunctional glycidyl ether derivative of bisphenol-A novolac, monomeric optical adhesives (such as thiolene), poly(ethylene glycol) diacrylate, and others.

In one embodiment, the monomer or oligomer is polymerizable using heat, light, or chemical species. After the coating is applied onto the negative stamp 24, the coating material is cured to form a cured coating material. A thin coating of a release agent also may be coated on the negative stamp 24 prior to coating the monomer or oligomer on the negative stamps 24 to facilitate removal of negative stamps 24 after curing. Typically, the curing facilitates polymerization and removal of solvent from the coating. In one embodiment, the coating is polymerized to form a plurality of microfluidic channels 12. Polymerization may occur by any method known to one of ordinary skill in the art and includes, but is not limited to, heat treatments, ultraviolet light treatments, visible light treatments, chemical exposure (for example to moisture), and the like. After curing, the processing substrate 22 is separated along with the negative stamps 24, leaving behind a plurality of microfluidic channels 12 within the coating 20.

As shown in FIG. 2D, the device substrate 14 having an outlet 18 is attached to the coating 20. The device substrate 14 is attached such that the fluidic port 18 matches with at least one microfluidic channel 12 of the microfluidic chip 10. The surface of the device substrate 14 may be flat, cylindrical or any other conformal shape.

In one embodiment, prior to attaching the device substrate 14 to the coating 20, chemical or biological modification of the plurality of microfluidic channels 12 is done by disposing one or more reagent emitting materials into at least one of the plurality of the microfluidic channels 12 with a suitable spatially resolved deposition technique, such as inkjet printing, dip pen lithography, and the like. The reagent emitting material may include a reagent disposed in a host matrix. The reagent may be a chemical reagent or a biological reagent. The reagent may be in the form of a solid, gel, or may be encapsulated in the host matrix. In one embodiment, the reagent is a chemical reagent, such as an organic dye, an organic fluorophore, organic acid, base, semiconductor nanocrystal, metal nanoparticle, inorganic nanoparticle, metal oxide nanoparticle, and any other additive, for example, bromothymol blue, nile red, p-toluene sulfonic acid, triethanolamine, sodium hydroxide, CdSe quantum dots, Au, Ag nanoparticles, TiO₂ nanoparticles, and others. The host-matrix may include, poly(ethylene), pol(vinyl chloride), poly(vinyl alcohol), poly(acrylic acid), poly(carbophil), poly(acrylamide), poly(acrylate), poly(urethane), poly(dimethylsiloxane), poly-N-isopropylacrylamide, poly(2-hydroxyethyl methacrylate), and other matrix materials or combinations thereof.

Parameters, such as time to activate emission of the reagent, rate of emission of the reagent, duration of the emission of the reagent, and others may be varied depending on the host matrix, type of the reagent, position of the reagent in the host matrix, type of fluid, emission stability at different conditions, stimulus of the flow fluid, or the like.

The reagent may be situated either on the surface of the host matrix or may be located in the bulk of the host matrix. In the latter case, the reagent is configured to re-dissolve when exposed to a suitable fluidic material. In one embodiment, n-isopropyl acrylamide subunits are enclosed in polymers or copolymers. Depending on the position of the reagent into the host matrix, emission-activation time can be either short or long compared to the time scale of the sample manipulation in the microfluidic device. The reagent is preferably situated on the surface of the host matrix. Such incorporation of a reagent will lead to a rapid or instantaneous reagent emission during the sample-material interaction under a constant flow of the sample in the microfluidic device. The reagent may also be situated in the bulk of the host matrix. In such an arrangement, the sample is introduced to the reagent-emitting material, the flow is stopped, the reagent is released, and the flow continues into another section of the microfluidic device for further sample manipulation or analysis. For the multiple-use applications such as, for on-line monitoring using microfluidic devices and some others, it may be advantageous to have a capability of a discrete emission of the reagent. If the reagent is incorporated into a reagent emitting material 28 in a way that its activation time is relatively long, then a “stop-flow” sample introduction may be achieved.

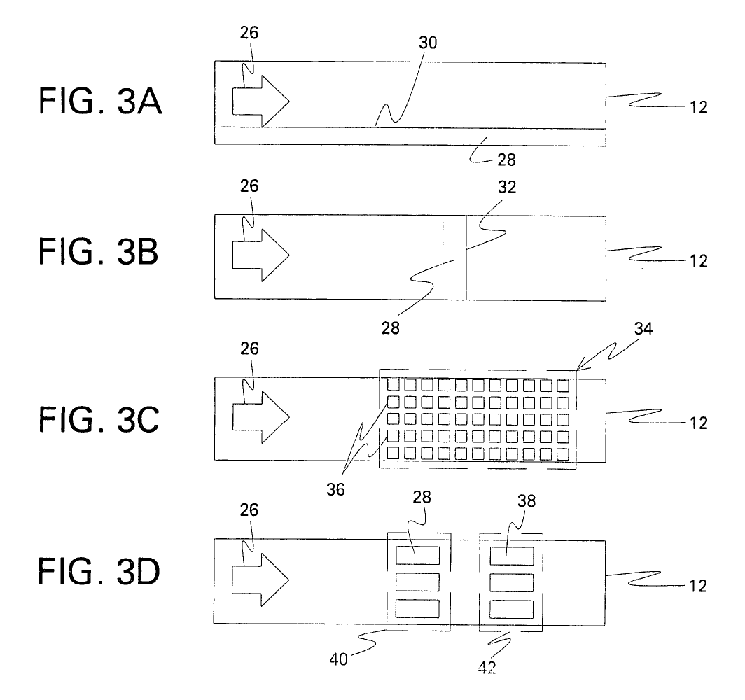

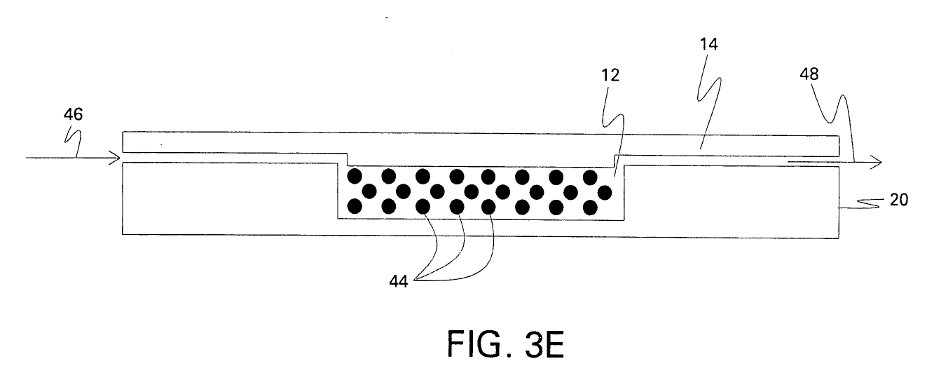

The reagent emitting material 28 may be disposed into the microfluidic channel 12 in various patterns. Such patterning of the reagent emitting material 28 facilitates effective release of the reagent. Multiple reagents may be emitted from a single reagent emitting material 28 or different reagent emitting materials 28. FIGS. 3A-3E show alternate embodiments of the predetermined pattern of the reagent emitting material 28 in the microfluidic channel 12 having a fluid flow shown by the arrow 26. In FIG. 3A the microfluidic channel 12 has a reagent emitting material 28 in the shape of a layer 30. The layer 30 is parallel to the direction of the fluid flow shown by the arrow 26. In FIG. 3B the microfluidic channel 12 has the reagent emitting material 28 in the shape of a disc 32. The disc 32 is disposed in a direction perpendicular to the direction of fluid flow as shown by arrow 26. In FIG. 3C the microfluidic channel 12 has the reagent emitting material 28 in the shape of a grid 34. The grid includes plurality of pixels 36 of the reagent emitting material 28. In FIG. 3D reagent emitting materials 28 and 38 are arranged in the microfluidic channel 12 in the form of stacks 40 and 42, respectively. The stacks 40, 42 have either the same or different reagent emitting materials and/or host matrices.

In FIG. 3E, the reagent is encapsulated in the host matrix to form encapsulants 44, which are then disposed in the microfluidic channel 12. The encapsulants 44 emit reagent on exposure to fluid flow. Arrows 46 and 48 show the direction of the inlet and outlet of the fluid, respectively. The system illustrated in FIG. 3E may be constructed in single or multi-layers, and may include one region containing a well storing the encapsulated material. Flow through the microfluidic channels 12 is controlled by ports lines that either are fabricated in the same layer as the holding chamber or placed in a second layer that is stacked to produce the full fluidic device. The encapsulants 44 are shown as spheres, but could be in any shape or form larger than the inlet port cross-sectional area. Any encapsulated shape or size may be incorporated that could be added in a similar processing step but does not require specific deposition or immobilization chemistry.

Further such an encapsulant 44 may be used for filtration. In such a case, the encapsulant of specific diameters is packed into the microfluidic channel. The fluid flowing past the spheres is then limited by the largest passage between the spheres, or between the spheres and the walls of the microfluidic channels. These spheres could be made of non-reactive materials, e.g., TEFLON®, so that restriction is based primarily on physical dimensions.

In one embodiment of the invention, the reagent emitting material is configured to predictably release reagent in response to a stimulus, such as pressure, flow, type of fluid, presence of a pre-selected component, host matrix, diffusion kinetics, pH, ionic strength, surfactants, oxidant, reductant, and the like. For example, the reagent emission control scheme may be devised where perturbing the transfer coefficient across a permeable substrate can control the dissolution rate. This may be stimulated physically in a way that increases the diffusion of reagent, e.g., heating a porous material encapsulating or covering the additive, or this may be accomplished by covering or encapsulating the material in a chemically responsive material that will produce controlled diffusion by adjusting a chemical parameter, e.g. the pH of the diluent's flow. These diffusion limiting barriers can be adsorbed, chemisorbed, or reacted into the support substrate to immobilize the controlling network.

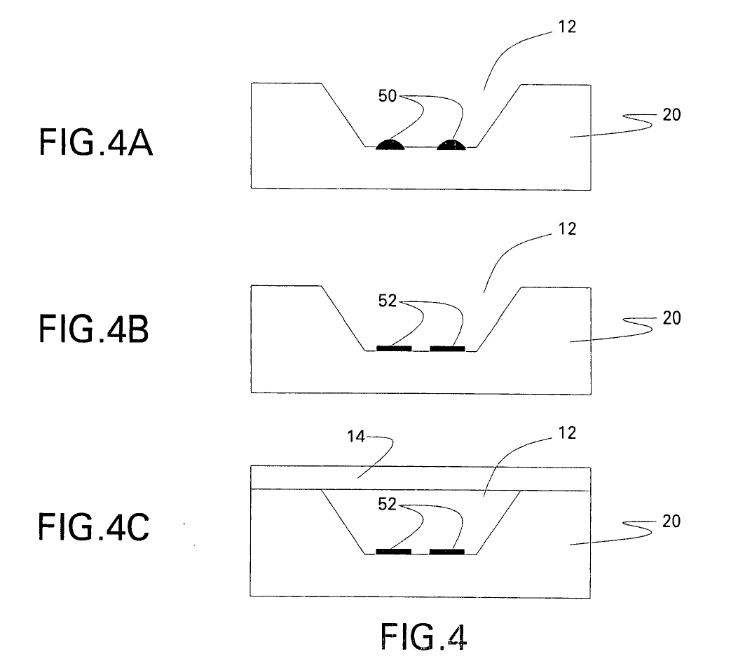

In one embodiment of the invention, the reagent emitting material is mixed with a solvent to form a solution, which is then disposed in the microfluidic channel 12 to form a predetermined pattern of the reagent emitting material inside the microfluidic channels 12. Typically, the solvent may be any compound that dissolves the reagent emitting material to form a solution and do not react with the microfluidic channel 12. In one embodiment, the solution containing the host matrix, one or more reagents, and the solvent is deposited in the form of mounds 50 within the microfluidic channel 12 surrounded by a coating 20 as shown in FIG. 4A. As the solvent evaporates, thin films 52 containing the host matrix and reagent(s) are formed within the microfluidic channel 12 as shown in FIG. 4B. The device substrate 14 of the microchannel is then attached to complete the device as shown in FIG. 4C.

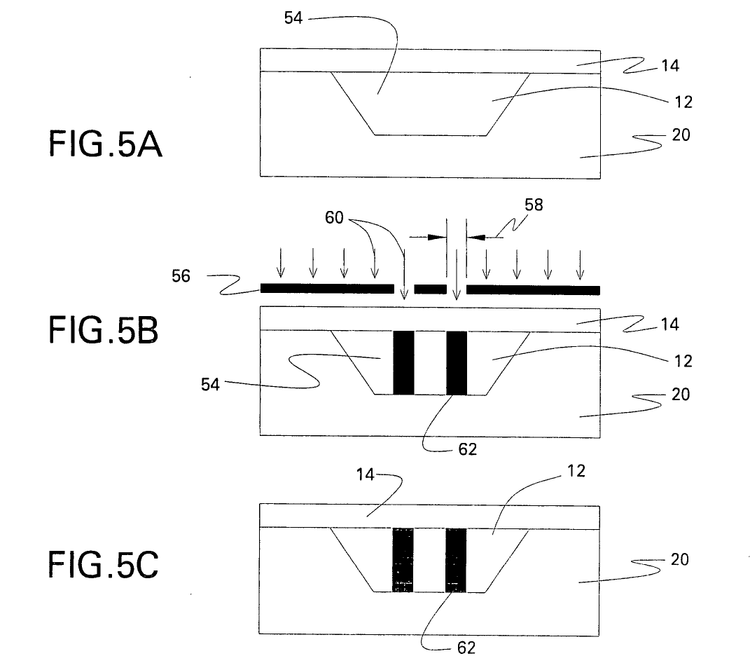

FIGS. 5A-5C show another embodiment of the invention whereby the host matrix is a photoactive matrix. Photolithography may be used to immobilize a part of the photoactive matrix to facilitate fabrication of a predetermined pattern of the reagent emitting material in the microfluidic channel. The microfluidic channel 12 is filled with a photoactive solution 54 having the photoactive matrix and the reagent. A photomask 56 is then disposed on the microfluidic channel 12. A predetermined portion 58 of the photomask 56 allows for the penetration of light 60 onto the photoactive solution 54. This exposure of light 60 induces solidification of the photoactive solution 54. The remaining unreacted photoactive solution 54 is removed and the microfluidic channel 12 is rinsed, leaving the pattern 62 formed by the reacted and now solid or semi-solid photoactive solution 54 within the microfluidic channel 12.

### EXAMPLES

Spectroscopic measurements of reflected light were performed using a set-up that included a white light source (Tungsten lamp, Ocean Optics, Inc., Dunedin, Fla.) and a portable spectrometer (Ocean Optics, Inc., Model ST2000). The spectrometer was equipped with a 600-grooves/mm grating blazed at 400 nm and a linear CCD-array detector. The spectrometer covered the spectral range from 250 to 800 nm with efficiency greater than 30%. Light from the lamp was focused into one of the arms of a “six-around-one” bifurcated fiber-optic reflection probe (Ocean Optics, Inc., Model R400-7-UV/VIS). The common arm of the probe illuminated a chemically functionalized region of the microfluidic chip at a small angle relative to the normal to the surface. The second arm of the probe was coupled to the spectrometer.

The reagent bromocresol green was dissolved in 1-methoxy-2-propanol (Dowanol) obtained from Aldrich (Milwaukee, Wis.) and a polymer binder was added to the reagent mixture.

### Example 1

Cross-Penetrating Microfluidic Channels Forming a Network

Negative stamps were fabricated on a quartz substrate (Quartz glass from Corning) in the form of a network using a commercially available direct write system (Micropen by Ohmcraft, Inc.). A monomer ink containing Ba—Al—Si oxide glass particles suspended in terpineol and ethyl cellulose binder by Heraeus-IP9105HTB obtained from Aldrich (Milwaukee, Wis.) was further applied onto the negative stamps. Curing of the ink was performed at 850° C. for 2 hours in air to form a structure having a network of microfluidic channels. The network of the microfluidic channels was removed form the negative stamps along with the glass substrate positioned onto a device substrate. The device substrate had the ports drilled for the two inputs and an output of the fluids.

Testing of the microfluidic device was performed with two flows entering the chip and one flow leaving the chip. In this configuration, on-chip mixing was evaluated. For the evaluations, two types of fluids were used. The first fluid was a pH dye (Bromocresol green) obtained from Aldrich (Milwaukee, Wis.) dissolved in water at low pH of 3.5 providing a yellow color. Another water sample at high pH (pH 8.5) was made to flow inside the chip. Upon solution change, the color of the pH dye was changing from yellow to blue. Upon introduction of the two fluids, the mixing occurred on chip as was evidenced by the rapid color change of the pH dye from yellow to blue.

Further, the fluorescent dye was dissolved in water. The solution was introduced into the fluidic chip from two ports. The fluorescence image of the microfluidic chip was taken using system described below

Surface functionalization of microfluidic channels having a low pH solution of Bromocresol green was further performed for chemical sensing directly in microfluidic channels. An assembled fiber-optic system was used for the determination of the changes in absorption spectrum of the sensor regions upon operation of the microfluidic chip. Spectroscopic measurements of reflected light were performed using a fiber-optic system set-up that included a white light source (Tungsten lamp, Ocean Optics, Inc., Dunedin, Fla.) and a portable spectrometer (Ocean Optics, Inc., Model ST2000). The spectrometer was equipped with a 600-grooves/mm grating blazed at 400 nm and a linear CCD-array detector. The spectrometer covered the spectral range from 250 to 800 nm with efficiency greater than 30%. Light from the lamp was focused into one of the arms of a “six-around-one” bifurcated fiber-optic reflection probe (Ocean Optics, Inc., Model R400-7-UV/VIS). The common arm of the probe illuminated a chemically functionalized region of the microfluidic chip at a small angle relative to the normal to the surface. The second arm of the probe was coupled to the spectrometer. Results of the demonstration of optical detection of a chemical sensor region in the microfluidic channels were detected by change in colorimetric signals upon the variation of pH from pH 3.5 to pH 8.5 in the microfluidic channels.

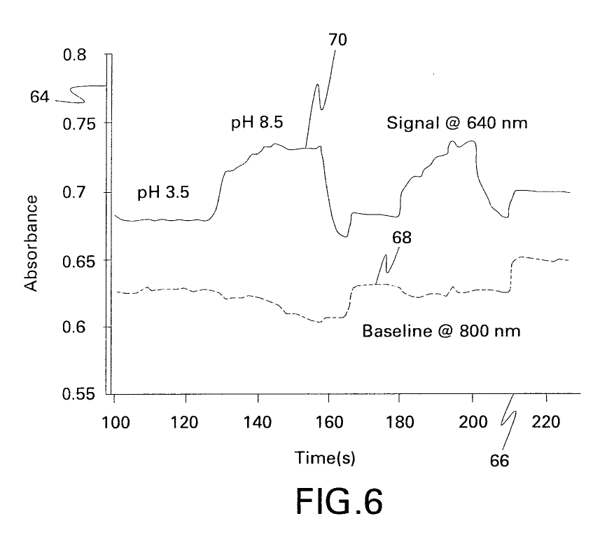

Absorbance spectra of the immobilized chemical sensor region in the microfluidic channels are shown in FIG. 6. Absorbance is shown on y-axis 64 and the time is shown on x-axis 66. The reagent bromocresol green was dissolved in Dowanol and a polymer binder was added to the reagent mixture. The baseline absorbance spectra at 800 nm wavelength as a function of the measurement time upon variation of pH in microfluidic channel from pH 3.5 to pH 8.5 are shown by reference numeral 68. The absorbance spectra of the reagent at 640 nm wavelength were changing as a function of measurement time upon the variation of pH in the microfluidic channel from pH 3.5 to pH 8.5 as shown by graph 70.

### Example 2

Reagent Situated in the Bulk of the Host Matrix

For the demonstration of the “stop-flow” configuration, a reagent-emitting material was developed to indicate the change in solvent polarity. Such change of solvent polarity is often observed during chemical reactions. The reagent-emitting material comprised of a Nile Red fluorescent dye electro-statically attached to a polymer matrix. This material was cut about 300 μm by about 1500 μm segment and was immobilized inside a capillary to mimic the behavior in a microfluidic channel. The capillary dimensions were about 500 μm and matched the microfluidic channels.

The stop-flow performance of the reagent-emitting material was achieved using a fluid-propulsion system that incorporated a syringe pump operating at about 75 μL/min flow rate. Fluid of interest was introduced into the channel with the reagent-emitting material and the flow was stopped for about 30 seconds before the reagent-containing solution was brought to the detector region. After that, the flow started again and the fluid was moved across the detection region. The data obtained illustrated that with the stopped-flow configuration, a reagent-emitting material produced a relatively constant concentration profile over about 10-15 seconds.

### Example 3

Reagent Situated on the Surface of the Host Matrix

For the demonstration of the constant-flow configuration, a reagent-emitting material was developed to indicate the change in solvent polarity. The constant flow performance of the reagent-emitting material was achieved using a fluid propulsion system that incorporated a syringe pump operating at about 75 μL/min flow rate. Fluid of interest was introduced into the channel with the reagent-emitting material and the reagent-containing solution was brought to the detector region. This data illustrates that with the constant-flow configuration, a reagent-emitting material produces a gradient concentration profile over about 100 seconds.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed as new and desired to be protected by Letters Patent of the United States is:

1. A method for making a microfluidic device, comprising:
providing a processing substrate;
forming a negative stamp on the processing substrate using a direct write process;
disposing a coating material on the processing substrate;
curing the coating material to produce a cured coating material; and
separating the processing substrate and the negative stamp from the cured coating material, wherein a plurality of channels are formed in the cured coating material corresponding to a location of the negative stamp.

2. The method according to claim 1, wherein said processing substrate is a flat substrate.

3. The method according to claim 1, wherein said processing substrate is a non-flat substrate having flat and non-flat regions.

4. The method according to claim 1, wherein the processing substrate is a non-flat substrate and has at least one axis, and at least one aspect of the direct write process is applied as a serpentine channel as a spiral along at least one axis of the substrate.

5. The method according to claim 1, wherein the processing substrate is selected from the group consisting of silicon, glass, quartz, gold, and silver.

6. The method according to claim 1, wherein the coating comprises at least one monomer, wherein the monomer is polymerizable using heat, light, or chemical species.

7. The method according to claim 1, wherein the coating comprises at least one oligomer, wherein the oligomer is polymerizable using heat, light, or chemical species.

8. The method according to claim 1, wherein said curing the coating material comprises polymerization of the coating material.

9. The method according to claim 8, wherein said polymerization is selected from the group consisting of annealing, blazing, and sintering.

10. The method according to claim 1, wherein said curing the coating material comprises solvent removal from the coating material.

11. The method of claim 1, further comprising placing a thin release agent coating on the negative stamp prior to applying the coating material to aid removal after curing.

12. The method according to claim 1, further comprising attaching a device substrate to the cured coating material adjacent to the plurality of channels.

13. The method according to claim 1, further comprising modifying the plurality of channels, wherein said modifying comprises disposing at least one reagent emitting material into at least one of the plurality of channels.

14. The method according to claim 13, wherein the reagent emitting material comprises a reagent disposed in a host matrix.

15. The method according to claim 14, wherein the host matrix is configured to predictably release the reagent in response to a stimulus.

16. The method according to claim 14, wherein the reagent comprises a solid.

17. The method according to claim 14, wherein the reagent comprises a gel.

18. The method according to claim 14, wherein the reagent comprises a photoactive matrix.

19. The method according to claim 14, further comprising disposing the reagent in the host matrix prior to said modifying the plurality of channels.

20. The method according to claim 14, further comprising encapsulating the reagent into the host matrix prior to said modifying the plurality of channels.

21. A method for making a microfluidic device, comprising:
providing a processing substrate;
forming a negative stamp on the processing substrate using a direct write process;
disposing a coating material on the processing substrate;
curing the coating material to produce a cured coating material;
separating the processing substrate and the negative stamp from the cured coating material;
attaching a device substrate to the cured coating material adjacent to the plurality of channels; and modifying the plurality of channels, wherein said modifying comprises disposing at least one reagent emitting material into at least one of the plurality of channels.

22. The method of claim 21, wherein said curing comprises polymerization of the coating material.

23. The method of claim 21, wherein the reagent emitting material comprises a reagent disposed in a host matrix.

24. The method of claim 23, wherein the host matrix is configured to predictably release the reagent in response to a stimulus.

25. The method of claim 23, further comprising disposing the reagent in the host matrix prior to said modifying the plurality of channels.

26. The method of claim 23, further comprising encapsulating the reagent into the host matrix prior to said modifying the plurality of channels.
